(19) United States
(12) Patent Application Publication
(10) Pub. No.: US 2023/0186283 A1
(43) Pub. Date: Jun. 15, 2023

(54) SYSTEMS AND METHODS FOR CRYPTOCURRENCY CHECKOUT

(71) Applicant: JPMORGAN CHASE BANK, N.A., New York, NY (US)

(72) Inventors: David Christopher CAREY, Middletown, DE (US); Howard SPECTOR, Woolwich, NJ (US); Peter G. COSTANZO, Dublin, OH (US); Sudhir UPADHYAY, Edison, NJ (US)

(21) Appl. No.: 17/547,024

(22) Filed: Dec. 9, 2021

(51) Int. Cl. G06Q 20/36; G06Q 20/40; G06Q 20/38; G06Q 20/02

(52) U.S. Cl. CPC G06Q 20/3678; G06Q 20/4037; G06Q 20/38215; G06Q 20/401; G06Q 20/02; G06Q 2220/00

(57) ABSTRACT

Systems and methods for systems and methods for cryptocurrency checkout are disclosed. According to one embodiment, a method may include a financial institution backend: receiving, from a merchant backend, control of a checkout flow for a transaction comprising an identification of a good or service to purchase, wherein the merchant backend accepts payment in cryptocurrency; receiving login credentials for the customer from the computer program; retrieving a plurality of customer accounts for the customer; receiving selection of one or more of the plurality of customer accounts to fund the cryptocurrency for the transaction; deducting a payment amount for the transaction from the one or more selected customer accounts; confirming payment to the merchant backend; returning control of the checkout flow to the merchant backend, wherein the merchant backend completes the transaction with the customer; and settling the transaction by providing a settlement amount in cryptocurrency to the merchant backend.

### BACKGROUND OF THE INVENTION

### 1. Field of the Invention

Embodiments relate to systems and methods for cryptocurrency checkout.

### 2. Description of the Related Art

With the rise of cryptocurrencies, merchants sometimes may request payment in cryptocurrency, but the customer may not hold any cryptocurrency. Similarly, customers may wish to pay using a certain type of cryptocurrency, and the merchant may not accept cryptocurrency, or may only accept a different type of cryptocurrency. Thus, either the merchant or the customer must change their payment or payment acceptance procedure to that the transaction may be completed.

### SUMMARY OF THE INVENTION

Systems and methods for systems and methods for cryptocurrency checkout are disclosed. According to one embodiment, a method for cryptocurrency checkout may include: (1) receiving, by a financial institution backend and from a merchant backend, control of a checkout flow for a transaction between the merchant backend and a computer program for a customer, the checkout flow comprising an identification of a good or service to purchase, wherein the merchant backend accepts payment in cryptocurrency; (2) receiving, by the financial institution backend, login credentials for the customer from the computer program; (3) retrieving, by the financial institution backend, a plurality of customer accounts for the customer; (4) receiving, by the financial institution backend, selection of one or more of the plurality of customer accounts to fund the cryptocurrency for the transaction; (5) deducting, by the financial institution backend, a payment amount for the transaction from the one or more selected customer accounts; (6) confirming, by the financial institution backend, payment to the merchant backend; (7) returning, by the financial institution backend, control of the checkout flow to the merchant backend, wherein the merchant backend completes the transaction with the customer; and (8) settling, by the financial institution backend, the transaction by providing a settlement amount in cryptocurrency to the merchant backend.

In one embodiment, the plurality of customer accounts may include a demand deposit account, a credit account, a line of credit account, and/or a reward/loyalty point account.

In one embodiment, the financial institution backend may deduct a fee from the one or more selected customer accounts in addition to the payment amount.

In one embodiment, the method may also include purchasing, by the financial institution backend, cryptocurrency of a type accepted by the merchant backend.

In one embodiment, the step of settling the transaction by providing a settlement amount in cryptocurrency to the merchant backend may include transferring, by the financial institution backend, the settlement amount in cryptocurrency from a financial institution cryptocurrency wallet to a merchant cryptocurrency wallet.

In one embodiment, the checkout flow may include an option to checkout with the financial institution backend.

According to another embodiment, a method for cryptocurrency checkout may include: (1) receiving, by a financial institution backend and from a merchant backend, control of a checkout flow for a transaction between the merchant backend and a computer program for a customer, the checkout flow comprising an identification of a good or service to purchase; (2) receiving, by the financial institution backend, login credentials for the customer from the computer program; (3) receiving, by the financial institution backend, selection to pay for the transaction with a cryptocurrency; (4) retrieving, by the financial institution backend, a customer cryptocurrency account that is linked to the financial institution backend; (5) transferring, by the financial institution backend, a payment amount for the transaction in cryptocurrency from the customer cryptocurrency account to a financial institution backend cryptocurrency account; (6) confirming, by the financial institution backend, payment to the merchant backend; (7) returning, by the financial institution backend, control of the checkout flow to the merchant backend, wherein the merchant backend completes the transaction with the customer; and (8) settling, by the financial institution backend, the transaction by providing a settlement amount in fiat currency to the merchant backend.

In one embodiment, the financial institution backend may retrieve a plurality of customer cryptocurrency accounts linked to the financial institution backend, and the financial institution backend receives a selection of one or more cryptocurrency account to pay for the transaction.

In one embodiment, the customer cryptocurrency account may be selected to pay for a first portion of the transaction, and the method may also include: retrieving, by the financial institution backend, a plurality of customer accounts for the customer, wherein the plurality of customer accounts comprise a demand deposit account, a credit account, a line of credit account, and/or a reward/loyalty point account; receiving, by the financial institution backend, selection of one or more of the customer accounts to pay for a second portion of the transaction; and deducting, by the financial institution backend, payment for the second portion of the transaction from the one or more selected customer accounts.

In one embodiment, the financial institution backend may deduct a fee from the customer cryptocurrency account in addition to the payment amount.

In one embodiment, the financial institution backend may deduct a fee from the one or more selected customer accounts.

In one embodiment, the checkout flow may include an option to checkout with the financial institution backend.

According to another embodiment, a system may include: a merchant backend comprising a computer program executing a checkout flow, wherein the merchant backend accepts cryptocurrency for transactions; a financial institution backend; and a customer electronic device associated with a customer and executing a computer program that interacts with the merchant backend. The computer program executed by the customer electronic device may select a good or service to purchase from the merchant backend in a transaction. The merchant backend may redirect a checkout flow for the transaction to the financial institution backend. The financial institution backend may receive login credentials for the customer from the computer program executed by the customer electronic device, may retrieve a plurality of customer accounts for the customer, may receive selection of one or more of the plurality of customer accounts to fund the cryptocurrency for the transaction, may deduct a payment amount for the transaction from the one or more selected customer accounts; may confirm payment to the merchant backend; and may return control of the checkout flow to the merchant backend. The merchant backend may complete the transaction with the customer and the financial institution backend may settle the transaction by providing a settlement amount in cryptocurrency to the merchant backend.

In one embodiment, the plurality of customer accounts may include a demand deposit account, a credit account, a line of credit account, and/or a reward/loyalty point account.

In one embodiment, the financial institution backend may deduct a fee from the one or more selected customer accounts in addition to the payment amount.

In one embodiment, the system may also include a cryptocurrency exchange in communication with the financial institution backend and comprising one or more cryptocurrency providers, and the financial institution backend may purchase cryptocurrency of a type accepted by the merchant backend from the cryptocurrency exchange.

In one embodiment, the financial institution backend may provide the settlement amount in cryptocurrency to the merchant backend by transferring the settlement amount in cryptocurrency from a financial institution cryptocurrency wallet to a merchant cryptocurrency wallet.

In one embodiment, the checkout flow may include an option to checkout with the financial institution backend.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 illustrates a system for cryptocurrency checkout according to one embodiment;

FIG. 2 depicts a method for cryptocurrency checkout according to one embodiment;

FIG. 3 depicts a method for cryptocurrency checkout according to another embodiment.

### DETAILED DESCRIPTION OF PREFERRED EMBODIMENTS

Embodiments are directed to systems and methods for cryptocurrency checkout.

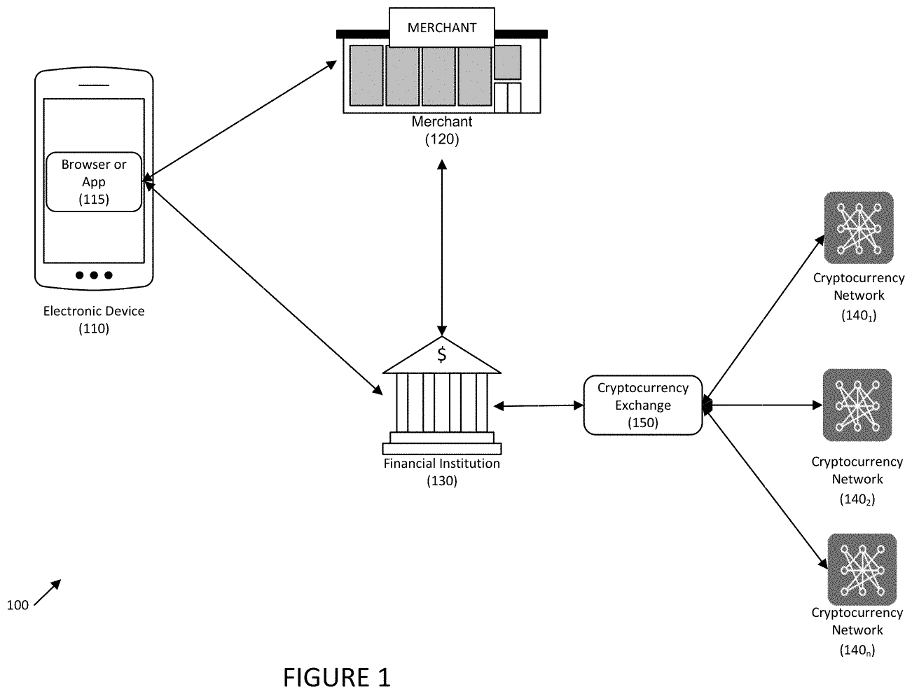

Referring to FIG. 1, a system for cryptocurrency checkout is illustrated according to one embodiment. System 100 may include customer electronic device 110, which may be any suitable electronic device that may be used for conducting an online transaction. Examples may include computers, smart devices, Internet of Things appliances, etc.

Electronic device 110 may execute browser or application (app) 115. Browser of app 115 may interface with an e-commerce backend at merchant 120.

Merchant 120 may be any entity that offers goods or services for purchase. As part of its checkout process, backend at merchant 120 may include an option for payment with financial institution 130.

Browser or app 115 may further interface with a backend for financial institution 130. Financial institution 130 may be a bank, a FinTech, etc.

Financial institution 130 may interface with a plurality of cryptocurrency networks 140₁, 140₂, . . . 140ₙ via cryptocurrency exchange 150. Each cryptocurrency network 140 may be associated with a different type of cryptocurrency, such as Bitcoin, Ethereum, Doge, etc. It should be recognized that these cryptocurrency types are exemplary only and other cryptocurrency types may be used as is necessary and/or desired.

Cryptocurrency exchange 150 may include one or more computer program that may facilitate the exchange of fiat currency to cryptocurrency and vice-versa, and between two types of cryptocurrencies. In one embodiment, cryptocurrency exchange may be a marketplace for financial institution 130, cryptocurrency networks 140, etc.

Financial institution 130 may provide the customer with an option to pay with one or more types of cryptocurrency.

In one embodiment, financial institution 130 may be in a consortium of financial institutions. A customer seeking to conduct a cryptocurrency transaction with a financial institution with which the customer does not have an account may have the customer's identify verified with the customer's financial institution. Member financial institutions may offer special pricing and incentives (e.g., reward points, discounts, etc.) to customers and other financial institutions for using them.

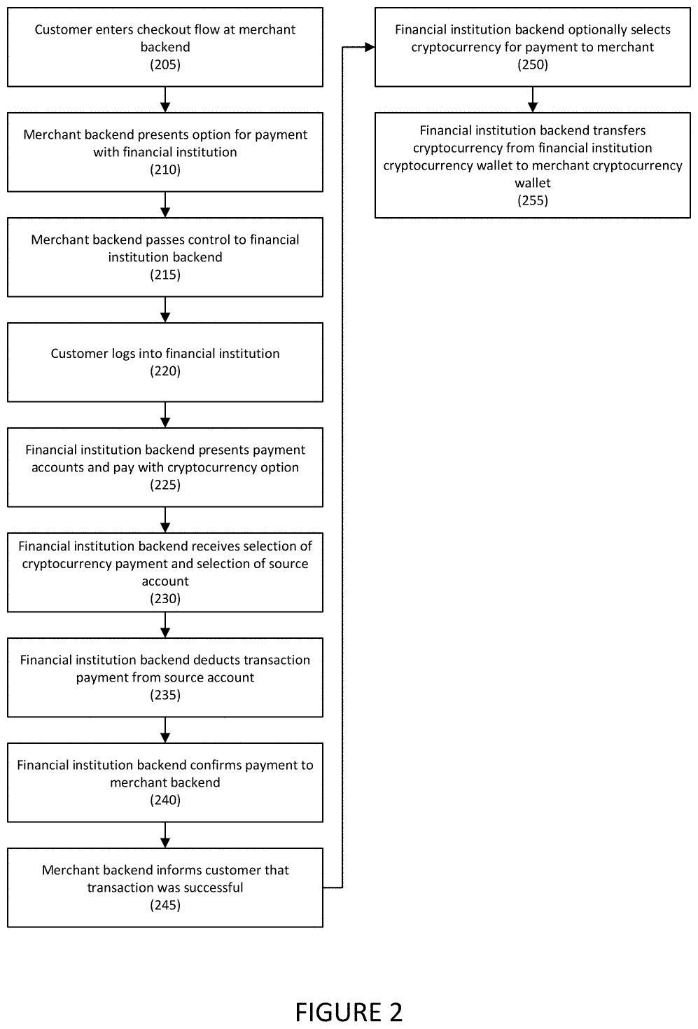

Referring to FIG. 2, a method for cryptocurrency checkout is provided according to one embodiment. In one embodiment, the merchant may accept cryptocurrency payments, and the customer may not have a cryptocurrency wallet.

In step 205, using a browser or an application, a customer may select good(s) or service(s) to purchase from a merchant, and may enter the merchant's checkout flow at the merchant backend.

In step 210, as part of its checkout flow, the merchant backend may present an option for the customer to pay with a financial institution that is a partner with the merchant. In one embodiment, the customer may or may not have an account with the financial institution.

In step 215, if the customer selects payment with the financial institution, the merchant backend may pass control of the checkout flow to the financial institution backend.

In 220, the customer may log into its account with the financial institution backend using, for example, login credentials. If the customer does not have an account with the financial institution, the customer may be offered an opportunity to create an account.

In step 225, the financial institution backend may retrieve the customers payment accounts (e.g., DDA, credit, line of credit, reward/loyalty points, etc.), including a pay with cryptocurrency option if the merchant is so enrolled. In one embodiment, the financial institution backend may present conversion rates and fees as necessary and/or desired.

In one embodiment, the financial institution backend may also present any fees charged by the financial institution for the service. In embodiments, the financial institution may also charge the merchant for using the service.

In step 230, the financial institution backend may receive a selection of a cryptocurrency payment option and a type of cryptocurrency, and a source a selection of one or more source account to fund the cryptocurrency exchange. In one embodiment, if the customer selected to use reward/loyalty points, additional conversion from loyalty points to dollars may be performed.

In step 235, the financial institution backend may deduct payment for the cryptocurrency from the identified source account, and in step 240, confirms payment to merchant backend. The financial institution backend may then return control of the checkout flow to the merchant backend.

In step 245, the merchant backend may inform the customer that the transaction was successful, and the transaction with the customer may be completed.

In embodiments, the transaction with the customer may be completed before the financial institution conducts the cryptocurrency exchange. This is due to the time required for the cryptocurrency exchange to take place.

In step 250, if not selected by the merchant, the financial institution backend may select a cryptocurrency type for payment to the merchant. In one embodiment, the cryptocurrency type may be limited to the types of cryptocurrencies accepted by the merchant. This may be set during merchant enrollment.

In one embodiment, if the financial institution backend already has cryptocurrency of the specific type, step 250 may not be required.

In step 255, the financial institution backend may execute a cryptocurrency transfer from a financial institution cryptocurrency wallet to a merchant cryptocurrency wallet.

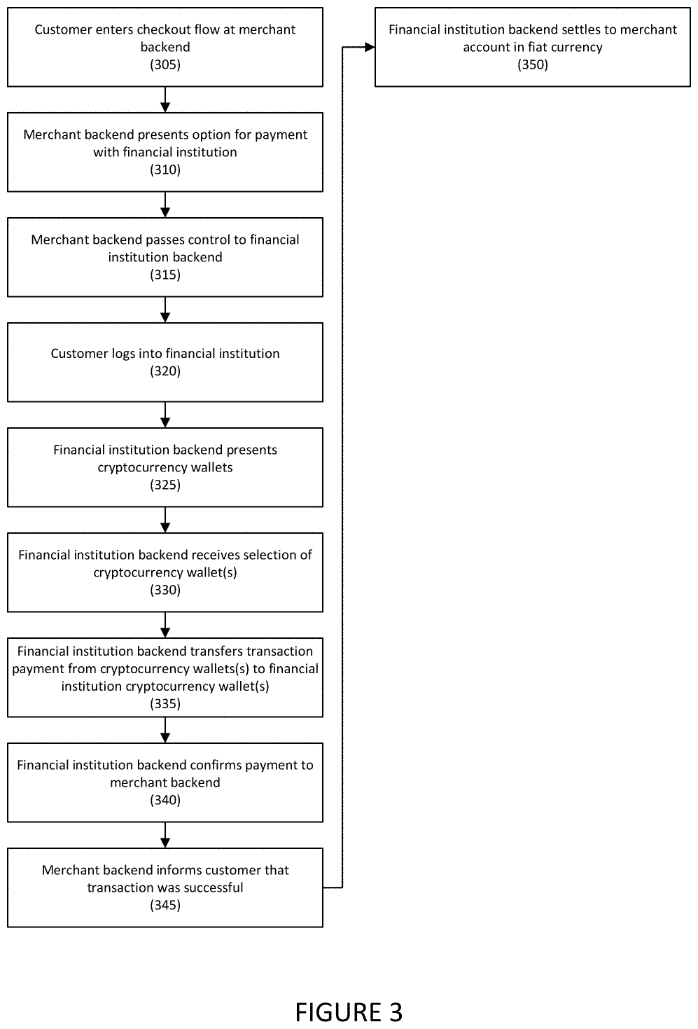

Referring to FIG. 3, a method for cryptocurrency checkout is provided according to another embodiment. The customer may want to pay with cryptocurrency, and the merchant may not accept cryptocurrency.

In step 305, using a browser or an application, a customer may select good(s) or service(s) to purchase from a merchant, and may enter the merchant's checkout flow at the merchant backend. This may be similar to step 205, above.

In step 310, as part of its checkout flow, the merchant backend may present an option for the customer to pay with a financial institution that is a partner with the merchant. In one embodiment, the customer may or may not have an account with the financial institution. This may be similar to step 305, above.

In step 315, if the customer selects payment with the financial institution, the merchant backend may pass control of the checkout flow to the financial institution backend. This may be similar to step 215, above.

In 320, the customer may log into its account with the financial institution backend. If the customer does not have an account with the financial institution, or has not linked its cryptocurrency wallets with the financial institution, or does not have a cryptocurrency wallet the customer may be offered an opportunity to create an account, or link the cryptocurrency wallets to the financial institution, or create a cryptocurrency wallet.

In step 325, the financial institution backend may retrieve and present the customer's cryptocurrency wallets to the customer for selection.

In one embodiment, the financial institution backend may also present any fees charged by the financial institution for the service. In embodiments, the financial institution may also charge the merchant for using the service.

In step 330, the financial institution backend may receive a selection of one or more cryptocurrency wallet(s) for payment. In one embodiment, the customer may further identify a non-cryptocurrency account for partial payment.

In step 335, the financial institution backend may transfer transaction payment from the identified cryptocurrency wallets(s) to financial institution cryptocurrency wallet(s). If the customer further identified one or more non-cryptocurrency account, the customer may transfer funds from those account(s).

In step 340, the financial institution backend may confirm payment to merchant backend, and may then return control of the checkout flow to the merchant backend.

In step 345, the merchant backend may inform the customer that the transaction was successful, and the transaction with the customer may be completed.

In embodiments, the transaction with the customer may be completed before the financial institution conducts the cryptocurrency exchange. This is due to the time required for the cryptocurrency exchange to take place.

In step 350, the financial institution backend may settle the transaction to the merchant account in fiat currency. In one embodiment, the settlement may be made using a business-as-usual process.

In embodiments, during a customer return, the customer may be provided with the option to receiving credit for the return in cash or to repurchase sufficient cryptocurrency to cover the value of the return. The amount of cryptocurrency may vary depending on market fluctuations, and may be more or less cryptocurrency than the original transaction. This may prevent fraud in the form of a return being made to take advantage of the cryptocurrency market.

In one embodiment, the financial institution may broker a nonfungible token (NFT) to customers to pay for the transaction with any overage going into the customer's account as cash, or redirecting the customer to purchase a cryptocurrency of the customer's choice For example, one or more trained machine learning algorithm may estimate the price of a NFT and offer the customer some percentage of that to spend on the transaction. Any overage minus any fees may be returned to the customer as cash or made available to the customer to purchase cryptocurrency. In embodiments, the amount avail to spend may be less than the estimated price of the NFT so to minimize any losses covered by the financial institution.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for cryptocurrency checkout, comprising:
receiving, by a financial institution backend and from a merchant backend, control of a checkout flow for a transaction between the merchant backend and a computer program for a customer, the checkout flow comprising an identification of a good or service to purchase, wherein the merchant backend accepts payment in cryptocurrency;
receiving, by the financial institution backend, login credentials for the customer from the computer program;
retrieving, by the financial institution backend, a plurality of customer accounts for the customer;
receiving, by the financial institution backend, selection of one or more of the plurality of customer accounts to fund the cryptocurrency for the transaction;
deducting, by the financial institution backend, a payment amount for the transaction from the one or more selected customer accounts;
confirming, by the financial institution backend, payment to the merchant backend;
returning, by the financial institution backend, control of the checkout flow to the merchant backend, wherein the merchant backend completes the transaction with the customer; and
settling, by the financial institution backend, the transaction by providing a settlement amount in cryptocurrency to the merchant backend.

2. The method of claim 1, wherein the plurality of customer accounts comprise a demand deposit account, a credit account, a line of credit account, and/or a reward/loyalty point account.

3. The method of claim 1, wherein the financial institution backend deducts a fee from the one or more selected customer accounts in addition to the payment amount.

4. The method of claim 1, further comprising:
purchasing, by the financial institution backend, cryptocurrency of a type accepted by the merchant backend.

5. The method of claim 1, wherein the step of settling the transaction by providing a settlement amount in cryptocurrency to the merchant backend comprises transferring, by the financial institution backend, the settlement amount in cryptocurrency from a financial institution cryptocurrency wallet to a merchant cryptocurrency wallet.

6. The method of claim 1, wherein the checkout flow comprises an option to checkout with the financial institution backend.

7. A method for cryptocurrency checkout, comprising:
receiving, by a financial institution backend and from a merchant backend, control of a checkout flow for a transaction between the merchant backend and a computer program for a customer, the checkout flow comprising an identification of a good or service to purchase;
receiving, by the financial institution backend, login credentials for the customer from the computer program;
receiving, by the financial institution backend, selection to pay for the transaction with a cryptocurrency;
retrieving, by the financial institution backend, a customer cryptocurrency account that is linked to the financial institution backend;
transferring, by the financial institution backend, a payment amount for the transaction in cryptocurrency from the customer cryptocurrency account to a financial institution backend cryptocurrency account;
confirming, by the financial institution backend, payment to the merchant backend;
returning, by the financial institution backend, control of the checkout flow to the merchant backend, wherein the merchant backend completes the transaction with the customer; and
settling, by the financial institution backend, the transaction by providing a settlement amount in fiat currency to the merchant backend.

8. The method of claim 7, wherein the financial institution backend retrieves a plurality of customer cryptocurrency accounts linked to the financial institution backend, and the financial institution backend receives a selection of one or more cryptocurrency account to pay for the transaction.

9. The method of claim 7, wherein the customer cryptocurrency account is selected to pay for a first portion of the transaction, and further comprising:
retrieving, by the financial institution backend, a plurality of customer accounts for the customer, wherein the plurality of customer accounts comprise a demand deposit account, a credit account, a line of credit account, and/or a reward/loyalty point account;
receiving, by the financial institution backend, selection of one or more of the customer accounts to pay for a second portion of the transaction; and
deducting, by the financial institution backend, payment for the second portion of the transaction from the one or more selected customer accounts.

10. The method of claim 7, wherein the financial institution backend deducts a fee from the customer cryptocurrency account in addition to the payment amount.

11. The method of claim 9, wherein the financial institution backend deducts a fee from the one or more selected customer accounts.

12. The method of claim 7, wherein the checkout flow comprises an option to checkout with the financial institution backend.

13. A system, comprising:
a merchant backend comprising a computer program executing a checkout flow, wherein the merchant backend accepts cryptocurrency for transactions;
a financial institution backend; and
a customer electronic device associated with a customer and executing a computer program that interacts with the merchant backend;
wherein:
the computer program executed by the customer electronic device selects a good or service to purchase from the merchant backend in a transaction;
the merchant backend redirects a checkout flow for the transaction to the financial institution backend;
the financial institution backend receives login credentials for the customer from the computer program executed by the customer electronic device;
the financial institution backend retrieves a plurality of customer accounts for the customer;
the financial institution backend receives selection of one or more of the plurality of customer accounts to fund the cryptocurrency for the transaction;
the financial institution backend deducts a payment amount for the transaction from the one or more selected customer accounts;
the financial institution backend confirms payment to the merchant backend;
the financial institution backend returns control of the checkout flow to the merchant backend;
the merchant backend completes the transaction with the customer; and
the financial institution backend settles the transaction by providing a settlement amount in cryptocurrency to the merchant backend.

14. The system of claim 13, wherein the plurality of customer accounts comprise a demand deposit account, a credit account, a line of credit account, and/or a reward/loyalty point account.

15. The system of claim 13, wherein the financial institution backend deducts a fee from the one or more selected customer accounts in addition to the payment amount.

16. The system of claim 13, further comprising a cryptocurrency exchange in communication with the financial institution backend and comprising one or more cryptocurrency providers, wherein the financial institution backend purchases cryptocurrency of a type accepted by the merchant backend from the cryptocurrency exchange.

17. The system of claim 13, wherein the financial institution backend provides the settlement amount in cryptocurrency to the merchant backend by transferring the settlement amount in cryptocurrency from a financial institution cryptocurrency wallet to a merchant cryptocurrency wallet.

18. The system of claim 13, wherein the checkout flow comprises an option to checkout with the financial institution backend.
